(19) United States
(12) Patent Application Publication
(10) Pub. No.: US 2011/0313127 A1
(43) Pub. Date: Dec. 22, 2011

(54) METHOD FOR PRODUCING POLYLACTIC ACID

(76) Inventors: Naruhito Iwasa, Osaka (JP); Katsuhito Miura, Osaka (JP); Yoshiro Furukawa, Osaka (JP)

(21) Appl. No.: 13/146,470

(22) PCT Filed: Jan. 29, 2010
(86) PCT No.: PCT/JP2010/051183

§ 371 Date: Sep. 9, 2011

(30) Foreign Application Priority Data
Jan. 30, 2009 (JP) 2009-020727
Feb. 9, 2009 (JP) 2009-026917

(51) Int. Cl. C08G 63/84; C08G 63/85; C08G 63/08

(52) U.S. Cl. 528/358; 528/357

(57) ABSTRACT

Provided is a method for producing polylactic acid comprising the step of a ring-opening polymerization of lactide in the presence of an alkylaluminum compound represented by the following formula (1):

R¹ₙAlX₃₋ₙ Formula (1)

(wherein n represents an integer of 1 to 3; R¹ may be the same or different and independently represents a linear or branched alkyl group having 1 to 10 carbon atoms; X may be the same or different and independently represents a halogen atom or a hydrogen atom; and Al represents an aluminum atom) as a ring-opening polymerization catalyst.

The ring-opening polymerization of lactide further effectively proceeds in the presence of at least one kind of metal compounds selected from the group consisting of aluminum compounds (except the alkylaluminum compounds represented by the above formula (1)), zinc compounds, titanium compounds, zirconium compounds, magnesium compounds, and calcium compounds.

### TECHNICAL FIELD

The present invention relates to a method for producing polylactic acid.

### BACKGROUND ART

Aliphatic polyesters typified by polylactic acid and polyglycolic acid show an excellent biodegradability and biocompatibility, and therefore are used for surgical sutures, microcapsules for injection drugs, bone fragment joining members, or the like in the field of medicament. Inter alia, polylactic acid, which is derived from lactic acid obtainable from fermented grains or wastes, attracts the most attention as an environmentally-friendly green plastic in place of conventional synthetic polymers derived from fossil materials, and research and development of polylactic acid is actively conducted.

As a method for synthesizing polylactic acid, polycondensation of lactic acid and ring-opening polymerization of lactide are widely known. Since the former method is an equilibrium reaction, in order to obtain a practical polymer having a high molecular weight, water produced as a by-product in the reaction must be thoroughly removed under conditions, such as high temperature and reduced pressure. In contrast, the latter method, which does not produce any by-product, is effective as a method for synthesizing polylactic acid having a high molecular weight.

As a polymerization catalyst effective in industrial production of polylactic acid by ring-opening polymerization, tin 2-ethylhexanoate, aluminum propoxide, and zinc lactate are widely known (Non Patent Literature 1).

Tin 2-ethylhexanoate is commercially available and easy to handle. For example, tin 2-ethylhexanoate is soluble in various organic solvents and is stable in the air. In addition, the catalytic activity of tin 2-ethylhexanoate is significantly high. Under usual conditions of melt polymerization (reaction temperature: 120 to 200° C.), polymerization is completed in several minutes, giving polylactic acid having a molecular weight of 100,000 to 1,000,000.

Tin 2-ethylhexanoate is approved as a food additive by FDA (Food and drug administration) in the US. However, many other tin compounds have toxicity. To avoid giving negative image to users or consumers, it is desired not to use tin 2-ethylhexanoate in production of polylactic acid, which may be used for medical purposes, etc.

Further, it is known that tin 2-ethylhexanoate remaining in a resulting polylactic acid causes depolymerization or an transesterification of the polylactic acid at the time of melt molding at a high temperature. Therefore, tin 2-ethylhexanoate is a factor decreasing the thermostability of polylactic acid.

In contrast, aluminum isopropoxide, which is as easily available and easy to handle as tin 2-ethylhexanoate, does not have the risk of toxicity-related negative image or of depolymerization at the time of melt molding, unlike tin 2-ethylhexanoate.

However, the catalytic activity of aluminum isopropoxide is extremely low as compared with tin 2-ethylhexanoate. Under usual conditions of melt polymerization at a reaction temperature of 120 to 200° C., a reaction time of several days is needed. In addition, the molecular weight of the resulting polymer is as low as 100,000 or less. Therefore, practical use of aluminum isopropoxide is difficult.

Zinc lactate, like aluminum isopropoxide, does not have the risk of toxicity-related negative image or of depolymerization at the time of melt molding but has an extremely low catalytic activity as compared with tin 2-ethylhexanoate. Therefore, zinc lactate is also inappropriate for practical use.

Further, such polymerization catalysts with low catalytic activity as aluminum isopropoxide and zinc lactate require prolonged reaction time before completion of the polymerization and accordingly have a problem of discoloration of the resulting polymer.

Therefore, polymerization catalysts that have a high catalytic activity comparable to that of tin 2-ethylhexanoate and are harmless to the human body and the environment are desired, and lately, many cases where aluminum compounds that are long known ring-opening polymerization catalysts are used as the polymerization catalyst for polylactic acid production have been reported.

For example, Patent Literature 1 discloses a method for producing polylactic acid by ring-opening polymerization of lactide in the presence of aluminum trifluoromethanesulfonate as a polymerization catalyst. The catalytic activity of aluminum trifluoromethanesulfonate is higher than that of the above-mentioned aluminum isopropoxide but is still practically insufficient because the reaction takes 6 hours or more. In addition, the resulting polylactic acid has a weight-average molecular weight as low as about 10,000, and therefore is less practical.

Patent Literature 2 discloses a method for producing polylactic acid by a ring-opening polymerization of a 30% by weight lactide solution in dichloromethane in the presence of a catalyst which is a mixture of A) a condensate obtainable from a thermal reaction of an aluminum alkoxide, silicon halide, and a phosphoric ester, and B) trialkylaluminum and/or dialkylaluminum chloride having C₁ to C₄ alkyl groups. This method enables production of a high-molecular-weight lactic acid polymer useful as a biodegradable polymer. However, the reaction time of this method is as long as several days, which means the catalytic activity is insufficient.

Patent Literature 3 discloses a method for producing polyester with good thermostability by a ring-opening polymerization of the cyclic dimer of α-hydroxy acid in the presence of a catalyst which is an uncharged complex of aluminum with β-diketone, such as aluminum tris(acetylacetonate) or aluminum dipivaloyl methanate, followed by decompression treatment of the polymer in a molten state at a later stage of or after completion of the reaction for removing low-molecular-weight compounds in the polymer. However, desired is a simpler method suitable for industrial production, that is, a production method not requiring any complicated steps, such as removal of residual monomers under reduced pressure.

### CITATION LIST

### Patent Literature

[Patent Literature 1]: JP 2005-54010 A
[Patent Literature 2]: JP 08-193127 A
[Patent Literature 3]: JP 09-12690 A

### Non Patent Literature

[Non Patent Literature 1]: Chemical Reviews, Vol. 104, No. 12, 6147-6176 (2004)

### SUMMARY OF INVENTION

### Technical Problem

An object of the present invention is to provide a method for producing polylactic acid in a short period of time in good yield in the presence of a green ring-opening polymerization catalyst that is harmless to the environment and the human body but possesses a very high catalytic activity.

### Solution to Problem

The present inventors made extensive examination to solve the problem described above, and found that a ring-opening polymerization of lactide in the presence of an alkylaluminum compound as a catalyst proceeds in a short period of time and requires only a small amount of the catalyst represented by the following formula (1):

R¹ₙAlX₃₋ₙ (1)

(wherein n represents an integer of 1 to 3; R¹ may be the same or different and independently represents a linear or branched alkyl group having 1 to 10 carbon atoms; X may be the same or different and independently represents a halogen atom or a hydrogen atom; and Al represents an aluminum metal atom) as a ring-opening polymerization catalyst.

The present inventors also found that the ring-opening polymerization of lactide further effectively proceeds in the presence of at least one kind of metal compounds selected from the group consisting of aluminum compounds (except the alkylaluminum compounds represented by the above formula (1)) zinc compounds, titanium compounds, zirconium compounds, magnesium compounds, and calcium compounds.

The present invention, which has been completed based on the above-mentioned findings, provides the following methods for producing polylactic acid.

[1] A method for producing polylactic acid comprising the step of ring-opening polymerization of lactide in the presence of an alkylaluminum compound represented by the following formula (1):

R¹ₙAlX₃₋ₙ (1)

(wherein n represents an integer of 1 to 3; R¹ may be the same or different and independently represents a linear or branched alkyl group having 1 to 10 carbon atoms; X may be the same or different and independently represents a halogen atom or a hydrogen atom; and Al represents an aluminum atom) as a ring-opening polymerization catalyst.
[2] The method according to the above [1], wherein the alkylaluminum compound represented by the above formula (1) is at least one kind of compounds selected from the group consisting of trimethylaluminum, triethylaluminum, triisobutylaluminum, trinormalhexylaluminum, trinormalbutylaluminum, trinormaloctylaluminum, diethylaluminum chloride, ethylaluminumsesquichloride, ethylaluminum dichloride, and diisobutylaluminum hydride.
[3] The method according to the above [1], further comprising the use of at least one kind of metal compounds selected from the group consisting of aluminum compounds (except the alkylaluminum compounds represented by the above formula (1)), zinc compounds, titanium compounds, zirconium compounds, magnesium compounds, and calcium compounds.
[4] The method according to the above [3], wherein the metal compound is at least one kind selected from the group consisting of compounds represented by the formula (2) below, compounds represented by the formula (3) below, compounds represented by the formula (4) below, compounds represented by the formula (5) below, compounds represented by the formula (6) below, and compounds represented by the formula (7) below:

Al(OR²)₃ (2)

Zn(OR³)₂ (3)

Ti(OR⁴)₄ (4)

Zr(OR⁵)₄ (5)

Mg(OR⁶)₂ (6)

Ca(OR⁷)₂ (7)

(wherein R² to R⁷ may be the same or different and each represent a linear or branched alkyl group having 1 to 12 carbon atoms, an optionally substituted aryl group having 1 to 4 rings, or a linear or branched acyl group having 1 to 12 carbon atoms; Al represents an aluminum atom; Zn represents a zinc atom; Ti represents a titanium atom; Zr represents a zirconium atom; Mg represents a magnesium atom; and Ca represents a calcium atom).
[5] The method according to the above [4], wherein the metal compound is at least one kind selected from the group consisting of aluminum triisopropoxide, aluminum trisecondarybutoxide, aluminum triethoxide, aluminum diisopropylate monosecondarybutyrate, aluminum ethylacetoacetate diisopropylate, aluminum tris(ethylacetoacetate), aluminum tris(acetylacetonate), aluminum bisethylacetoacetate monoacetylacetonate, (alkylacetoacetato)aluminum diisopropylate, aluminum trifluoroacetylacetonate, aluminum trilactate;
zinc acetylacetonate (bis(2,4-pentadionato)zinc(II)), zinc diacetate, zinc dimethacrylate, zinc dilactate; diisopropoxybis(ethylacetoacetate)titanium, tetraisopropoxytitanium(IV), tetranormalbutoxytitanium, tetrakis(2-ethylhexyloxy)titanium, tetrastearyloxytitanium, tetramethoxytitanium, diisopropoxybis(acetylacetonato)titanium, diisopropoxybis(2-ethyl-1,3-hexanediolato)titanium, diisopropoxybis(triethanolaminato)titanium, di(2-ethylhexoxy)bis(2-ethyl-1,3-hexanediolato)titanium, di-normalbutoxy bis(triethanolaminato)titanium, and tetraacetylacetonatetitanium.
[6] The method according to the above [5], wherein the metal compound is at least one kind selected from the group consisting of aluminum triisopropoxide, aluminum tris(ethylacetoacetate), aluminum tris(acetylacetonate), aluminum trilactate, zinc acetylacetonate(bis(2,4-pentadionato)zinc(II)), tetraisopropoxytitanium(IV), tetranormalbutoxytitanium, and tetrakis(2-ethylhexyloxy)titanium.
[7] The method according to the above [1], wherein the usage of the alkylaluminum compound represented by the formula (1) is 0.00001 to 1 mol % relative to 100 parts by weight of lactide.
[8] The method according to the above [3], wherein the usage of the metal compound is 0.00001 to 1 mol % relative to 100 parts by weight of lactide.
[9] The method according to the above [3], wherein the molar ratio of the usage of the alkylaluminum compound represented by the formula (1) relative to the usage of the metal compound is 0.1 to 10 equivalents.
[10] The method according to the above [1], wherein the lactide to be subjected to the polymerization is in a molten state.
[11] The method according to the above [10], wherein the reaction temperature is 100 to 200° C.

### Advantageous Effects of Invention

According to the method of the present invention for producing polylactic acid, polymerization proceeds in a short period of time in the presence of a small amount of a catalyst, efficiently producing a polylactic acid having a molecular weight sufficiently high for practical use. Because of the short reaction time, discoloration of the polymer can be suppressed. In addition, the obtained polylactic acid is excellent in safety and thermostability.

Hereinafter, the present invention will be described in detail.

### DESCRIPTION OF EMBODIMENTS

### Alkylaluminum Compound Catalyst

The alkylaluminum compound used in the present invention as a ring-opening polymerization catalyst is represented by the following formula (1):

R¹ₙAlX₃₋ₙ (1)

(wherein n represents an integer of 1 to 3; R¹ may be the same or different and independently represents a linear or branched alkyl group having 1 to 10 carbon atoms; X may be the same or different and independently represents a halogen atom or a hydrogen atom; and Al represents an aluminum metal atom).

The number of carbon atoms in the alkyl group represented by R¹ in the formula (1) is preferably 1 to 10, more preferably 1 to 8, and further more preferably 1 to 4. Examples of the halogen atom represented by X in the formula (1) include a fluorine atom, a chlorine atom, a bromine atom, and an iodine atom. X is preferably a chlorine atom or a bromine atom. n is preferably 3.

Specific examples of the alkylaluminum compound catalyst represented by the formula (1) include trimethylaluminum, triethylaluminum, triisobutylaluminum, trinormalhexylaluminum, trinormalbutylaluminum, trinormaloctylaluminum, diethylaluminum chloride, ethylaluminumsesquichloride, ethylaluminum dichloride, and diisobutylaluminum hydride. Inter alia, preferred are trimethylaluminum, triethylaluminum, triisobutylaluminum, trinormaloctylaluminum, and diethylaluminum chloride; and more preferred is triethylaluminum.

The alkylaluminum compound catalyst represented by the formula (1) may be used alone or in a combination of two or more kinds thereof.

### Metal Compound Catalyst

In the method of the present invention, as a ring-opening polymerization catalyst, metal compounds such as aluminum compounds (except the alkylaluminum compounds represented by the formula (1)), zinc compounds, titanium compounds, zirconium compounds, magnesium compounds, calcium compounds, indium compounds, iron compounds, cobalt compounds, lanthanum compounds, neodium compounds, samarium compounds, yttrium compounds, vanadium compounds, manganese compounds, nickel compounds, chromium compounds, and copper compounds can be used in addition to the above alkylaluminum compounds represented by the formula (1). The metal compound may be used alone or in a combination of two or more kinds thereof.

Inter alia, preferred are aluminum compounds (except the compounds represented by the formula (1)), zinc compounds, titanium compounds, zirconium compounds, magnesium compounds, and calcium compounds.

Specific example thereof include

aluminum compounds represented by the following formula (2):

Al(OR²)₃ (2)

(wherein R² may be the same or different and each represents a linear or branched alkyl group having 1 to 12 carbon atoms, an optionally substituted aryl group having 1 to 4 rings, or a linear or branched acyl group having 1 to 12 carbon atoms; and Al represents an aluminum atom),
zinc compounds represented by the following formula (3):

Zn(OR³)₂ (3)

(wherein R³ has the same meaning as the above R², and Zn represents a zinc atom),
titanium compounds represented by the following formula (4):

Ti(OR⁴)₄ (4)

(wherein R⁴ has the same meaning as the above R², and Ti represents a titanium atom),
zirconium compounds represented by the following formula (5):

Zr(OR⁵)₄ (5)

(wherein R⁵ has the same meaning as the above R², and Zr represents a zirconium atom),
magnesium compounds represented by the following formula (6):

Mg(OR⁶)₂ (6)

(wherein R⁶ has the same meaning as the above R², and Mg represents a magnesium atom), and
calcium compounds represented by the following formula (7):

Ca(OR⁷)₂ (7)

(wherein R⁷ has the same meaning as the above R², and Ca represents a calcium atom).

Inter alia, preferred are aluminum compounds represented by the above formula (2), zinc compounds represented by the above formula (3), and titanium compounds represented by the above formula (4).

The ring constituting the aryl group is not particularly limited as long as the entire functional group has aromaticity, and representative examples thereof include a phenyl group and a naphthyl group. Examples of the substituent in the aryl ring include alkyl groups having 1 to 6 carbon atoms, alkoxy groups having 1 to 6 carbon atoms, acyl groups having 1 to 8 carbon atoms, a halogen atom, an amino group, a hydroxyl group, a sulfonyl group, a carboxyl group, a cyano group, a nitro group, a vinyl group, an allyl group, and an isocyano group.

Specific examples of the aluminum compound represented by the formula (2) include aluminum triisopropoxide, aluminum trisecondarybutoxide, aluminum triethoxide, aluminum diisopropylate monosecondarybutyrate, aluminum ethylacetoacetate diisopropylate, aluminum tris(ethylacetoacetate), aluminum tris(acetylacetonate), aluminum bisethylacetoacetate monoacetylacetonate, (alkylacetoacetato)aluminum diisopropylate, aluminum trifluoroacetylacetonate, and aluminum trilactate.

Inter alia, preferred are aluminum triisopropoxide, aluminum trisecondarybutoxide, aluminum triethoxide, aluminum tris(ethylacetoacetate), aluminum tris(acetylacetonate), aluminum bisethylacetoacetate monoacetylacetonate, aluminum trifluoroacetylacetonate, and aluminum trilactate; and more preferred are aluminum triisopropoxide, aluminum tris(ethylacetoacetate), aluminum tris(acetylacetonate), and aluminum trilactate.

Specific examples of the zinc compound represented by the formula (3) include zinc acetylacetonate(bis(2,4-pentadionato)zinc(II)), zinc diacetate, zinc dimethacrylate, and zinc dilactate. Inter alia, preferred are zinc acetylacetonate(bis(2,4-pentadionato)zinc(II)) and zinc dilactate, and more preferred is zinc acetylacetonate(bis(2,4-pentadionato)zinc(II)).

Specific examples of the titanium compound represented by the formula (4) include diisopropoxybis(ethylacetoacetate)titanium, tetraisopropoxytitanium(IV), tetranormalbutoxytitanium, tetrakis(2-ethylhexyloxy)titanium, tetrastearyloxytitanium, tetramethoxytitanium, diisopropoxybis(acetylacetonato)titanium, diisopropoxybis(2-ethyl-1,3-hexanediolato)titanium, diisopropoxybis(triethanolaminato)titanium, di(2-ethylhexoxy)bis(2-ethyl-1,3-hexanediolato)titanium, di-normalbutoxy bis(triethanolaminato)titanium, and tetraacetylacetonatetitanium. Inter alia, preferred are tetraisopropoxytitanium(IV), tetranormalbutoxytitanium, tetrakis(2-ethylhexyloxy)titanium, and diisopropoxybis(acetylacetonato)titanium; and more preferred are tetraisopropoxytitanium(IV), tetranormalbutoxytitanium, and tetrakis(2-ethylhexyloxy)titanium.

Specific examples of the zirconium compound represented by the formula (5) include acetylacetonetributoxyzirconium, tetranormalbutoxyzirconium, zirconium acetylacetonate, tetratertiarybutoxyzirconium, tetraethoxyzirconium, and tetranormalpropoxyzirconium. Inter alia, preferred are tetranormalbutoxyzirconium, zirconium acetylacetonate, tetraethoxyzirconium, and tetranormalpropoxyzirconium.

Specific examples of the magnesium compound represented by the formula (6) include magnesium diacetylacetonate, magnesium ditertiarybutoxide; magnesium diethoxide, magnesium dimethoxide, and magnesium distearate. Inter alia, magnesium diethoxide and magnesium dimethoxide are preferred.

Specific examples of the calcium compound represented by the formula (7) include calcium diacetylacetonate, calcium bis(2-ethylhexanoate), calcium diisopropoxide, and calcium dimethoxide. Inter alia, calcium bis(2-ethylhexanoate) is preferred.

Specific examples of other metal compounds include indium acetylacetonate, indium acetate, indium isopropoxide, ferricacetylacetonate, ferricisopropoxide, ferric(2-ethylhexanoate), cobalt(II)acetate, cobalt(III)acetylacetonate, cobalt(II)(2-ethylhexanoate), lanthanum(III)isopropoxide, neodium(III)isopropoxide, samarium(III)isopropoxide, yttrium(III)isopropoxide, vanadium butoxide, manganese(II)acetate, manganese(II)acetylacetonate, nickel(II)acetylacetonate, nickel(II)(2-ethylhexanoate), chromium(III)acetylacetonate, and copper(II)acetylacetonate.

### Preferred Combinations of Alkylaluminum Compound Catalyst and Metal Compound Catalyst

Table 1 and Table 2 show preferred combinations of the alkylaluminum compound catalyst and the metal compound catalyst.

TABLE 1

| | Alkylaluminum | |
|---|---|---|
| Number | compound catalyst | Metal compound catalyst |
| 1 | Trimethylaluminum | Aluminum triisopropoxide |
| 2 | Trimethylaluminum | Aluminum tris(acetylacetonate) |
| 3 | Trimethylaluminum | Aluminum tris(ethylacetoacetate) |
| 4 | Trimethylaluminum | Aluminum trilactate |
| 5 | Trimethylaluminum | Aluminum trisecondarybutoxide |
| 6 | Trimethylaluminum | Aluminum triethoxide |
| 7 | Trimethylaluminum | Zinc dilactate |
| 8 | Trimethylaluminum | Zinc acetylacetonate |
| | | (bis(2,4-pentadionato)zinc(II)) |
| 9 | Trimethylaluminum | Tetraisopropoxytitanium(IV) |
| 10 | Trimethylaluminum | Tetranormalbutoxytitanium |
| 11 | Trimethylaluminum | Tetrakis(2-ethylhexyloxy)titanium |
| 12 | Trimethylaluminum | Diisopropoxybis(acetylacetonato)titanium |
| 13 | Triethylaluminum | Aluminum triisopropoxide |
| 14 | Triethylaluminum | Aluminum tris(acetylacetonate) |
| 15 | Triethylaluminum | Aluminum tris(ethylacetoacetate) |
| 16 | Triethylaluminum | Aluminum trilactate |
| 17 | Triethylaluminum | Aluminum trisecondarybutoxide |
| 18 | Triethylaluminum | Aluminum triethoxide |
| 19 | Triethylaluminum | Zinc dilactate |
| 20 | Triethylaluminum | Zinc acetylacetonate |
| | | (bis(2,4-pentadionato)zinc(II)) |
| 21 | Triethylaluminum | Tetraisopropoxytitanium(IV) |
| 22 | Triethylaluminum | Tetranormalbutoxytitanium |
| 23 | Triethylaluminum | Tetrakis(2-ethylhexyloxy)titanium |
| 24 | Triethylaluminum | Diisopropoxybis(acetylacetonato)titanium |

TABLE 2

| | Alkylaluminum | |
|---|---|---|
| Number | compound catalyst | Metal compound catalyst |
| 25 | Triisobutylaluminum | Aluminum triisopropoxide |
| 26 | Triisobutylaluminum | Aluminum tris(acetylacetonate) |
| 27 | Triisobutylaluminum | Aluminum tris(ethylacetoacetate) |
| 28 | Triisobutylaluminum | Aluminum trilactate |
| 29 | Triisobutylaluminum | Aluminum trisecondarybutoxide |
| 30 | Triisobutylaluminum | Aluminum triethoxide |
| 31 | Triisobutylaluminum | Zinc dilactate |
| 32 | Triisobutylaluminum | Zinc acetylacetonate |
| | | (bis(2,4-pentadionato)zinc(II)) |
| 33 | Triisobutylaluminum | Tetraisopropoxytitanium(IV) |
| 34 | Triisobutylaluminum | Tetranormalbutoxytitanium |
| 35 | Triisobutylaluminum | Tetrakis(2-ethylhexyloxy)titanium |
| 36 | Triisobutylaluminum | Diisopropoxybis- |
| | | (acetylacetonato)titanium |
| 37 | Trinormaloctylaluminum | Aluminum triisopropoxide |
| 38 | Trinormaloctylaluminum | Aluminum tris(acetylacetonate) |
| 39 | Trinormaloctylaluminum | Aluminum tris(ethylacetoacetate) |
| 40 | Trinormaloctylaluminum | Aluminum trilactate |
| 41 | Trinormaloctylaluminum | Aluminum trisecondarybutoxide |
| 42 | Trinormaloctylaluminum | Aluminum triethoxide |
| 43 | Trinormaloctylaluminum | Zinc dilactate |
| 44 | Trinormaloctylaluminum | Zinc acetylacetonate |
| | | (bis(2,4-pentadionato)zinc(II)) |
| 45 | Trinormaloctylaluminum | Tetraisopropoxytitanium(IV) |
| 46 | Trinormaloctylaluminum | Tetranormalbutoxytitanium |
| 47 | Trinormaloctylaluminum | Tetrakis(2-ethylhexyloxy)titanium |
| 48 | Trinormaloctylaluminum | Diisopropoxybis- |
| | | (acetylacetonato)titanium |

### Catalyst Usage

The usage of the alkylaluminum compound catalyst represented by the formula (1) is preferably about 0.00001 to 1 mol %, more preferably about 0.00005 to 0.5 mol %, and further more preferably about 0.001 to 0.5 mol % relative to the usage of lactide. When the usage is within the above-mentioned range, sufficient catalytic activity can be obtained.

The usage of the above-mentioned metal compound catalyst is preferably about 0.00001 to 1 mol %, more preferably about 0.00005 to 0.5 mol %, and still more preferably about 0.001 to 0.5 mol % relative to the usage of lactide.

The molar usage ratio of the alkylaluminum compound catalyst to the metal compound catalyst is preferably about 0.1 to 10 equivalents, more preferably about 0.5 to 5 equivalents, and still more preferably about 1 to 3 equivalents. When the usage of the alkylaluminum compound catalyst relative to the usage of the metal compound catalyst is not less than the above-mentioned lower limit, practically sufficient activity can be obtained. Also, when the usage is not more than the above-mentioned upper limit, practically sufficient activity can be obtained and the resulting polylactic acid has a molecular weight sufficiently high for practical use.

### Lactide

Examples of the lactide that can be used for polymerization in the present invention include L-lactide, D-lactide, meso-lactide, and rac-lactide. The lactide may be used alone or as a mixture of two or more kinds thereof. The lactide may be obtained by the reaction of a synthetic lactic acid or a lactic acid obtained by fermentation.

### Solvent

In the present invention, the ring-opening polymerization may be performed without using any solvent, or in the presence of a reaction solvent. Examples of the reaction solvent include aromatic hydrocarbons such as benzene, toluene, and xylene; ethers, such as diethylether, dibutylether, and tetrahydrofuran; saturated aliphatic hydrocarbons such as pentane, hexane, cyclohexane, and octane; halogen-containing hydrocarbons, such as methylenechloride and chloroform; acetone; 1,4-dioxane dimethylformamide; and dimethylsulfoxide. Inter alia, aromatic hydrocarbons and saturated aliphatic hydrocarbons are preferred, and toluene, xylene, and hexane are more preferred. The solvent is suitably selected depending on the polymerization temperature.

The solvent may be used alone or in a combination of two or more kinds thereof.

The usage of the solvent may be about 100 to 1000 parts by weight, preferably about 100 to 800 parts by weight, and more preferably about 100 to 500 parts by weight relative to 100 parts by weight of lactide.

### Reaction Conditions

Lactide is solid at ordinary temperature and ordinary pressure. When lactide is heated to 90° C. or higher at ordinary pressure, a part or the whole thereof will be in a molten state. The state of the lactide in the ring-opening polymerization is not particularly limited. However, for uniform reaction, the lactide is preferably in a molten state or a solution state.

A polymerization in which lactide is reacted in its molten state, namely melt polymerization, can produce more of the polymer in a reaction vessel of the same volume as compared with polymerization in a solution state because the reaction substantially does not require any solvent. In addition, melt polymerization has advantages of substantially not requiring solvent removal after the reaction and of higher reaction rate as compared with polymerization in a solution state. However, in the present invention, it is not excluded to use not more than about 10 parts by weight of a solvent relative to 100 parts by weight of lactide.

By contrast, polymerization in a solution state has an advantage that the polymerization can proceed at low temperature and therefore allows the presence of a thermally unstable catalyst or additive.

The reaction temperature is usually about 40 to 200° C. In the case of melt polymerization, the reaction temperature should be not less than 90° C. at which lactide melts, and preferably about 100 to 200° C., more preferably about 140 to 200° C., and still more preferably about 140 to 180° C. When a solvent is used in the melt polymerization, the reaction temperature should be lower than the boiling point of the solvent. When the reaction temperature is within the above temperature range, the reaction proceeds effectively and heat-induced discoloration of the resulting polymer can be prevented. In the case of solution polymerization, the reaction temperature is preferably not less than about 40° C., and more preferably not less than about 60° C. Within the above temperature range, the reaction proceeds effectively. The upper limit of the reaction temperature in the solution polymerization should be lower than the boiling point of the solvent.

The reaction time is usually about 1 to 120 minutes.

The polymerization is usually performed with stirring.

The mixing order of each component used for the reaction is not particularly limited, and for example, lactide, a solvent if needed, an alkylaluminum compound catalyst, and a metal compound catalyst if needed may be added to a reaction vessel all at the same time for reaction. In the case of melt polymerization, a preferred procedure for improved uniformity of the reaction is as follows: lactide is placed in a reaction vessel first and heated, and at the time the lactide reaches a molten state, an alkylaluminum compound catalyst and a metal compound catalyst if needed are added. In the case where a metal compound catalyst is used, a preferred procedure for a simpler procedure is as follows: lactide and the metal compound catalyst are placed in a reaction vessel and heated, and at the time the lactide reaches a molten state, an alkylaluminum compound catalyst is added.

### Resulting Polylactic Acid

The weight-average molecular weight of the polylactic acid obtained by the above-mentioned method of the present invention is usually about 50,000 to 500,000. The color of the obtained polylactic acid is usually colorless white or light yellow.

The polylactic acid obtained by the production method of the present invention may be used for a polylactic acid composition that comprises a suitable additive depending on the intended use. Specific examples of the polylactic acid composition include compositions that comprise polylactic acid obtained by the method of the present invention and an additive, such as a plasticizer, an antioxidant, a light stabilizer, an ultraviolet absorber, a thermostabilizer, a lubricant, a release agent, various fillers, an antistatic agent, a flame retardant, a foaming agent, a filler, an antimicrobial agent, an antifungal agent, a nucleating agent, and a colorant including a dye and a pigment. The additive may be used alone or in a combination of two or more kinds thereof.

With the use of the polylactic acid obtained by the production method of the present invention, an injection-molded product, an extrusion-molded product, a vacuum or pressure-molded product, a blow-molded product, a film, a nonwoven sheet, a fiber, a cloth, and a composite with another material can be produced. The mold products may be materials for agriculture, fishery, civil engineering or construction; stationery; medical supplies; or the like. Such molding can be performed in the usual manner.

### EXAMPLES

Hereinafter, the invention will be described in more detail by referring to the Examples below. However, the present invention is not limited to the Examples unless the invention deviates from the scope of the invention.

### Example 1

In a Schlenk flask, 10.0 g (69.4 mmol) of L-lactide and a stirrer were placed. The lactide was vacuum-dried for 1 hour, and replacement by nitrogen gas was performed. In the nitrogen atmosphere, the lactide was heated to 140° C. After melting of the L-lactide was confirmed, 31 μL of a 15 wt % triethylaluminum/toluene solution (34 μmol) was added as an alkylaluminum compound catalyst, and polymerization was allowed to proceed for 10 minutes at 140° C. At the bottom of the Schlenk flask, a whitish polymer was produced.

### Example 2

Polymerization was performed in the same procedure as in Example 1 except that 34 μL of a 1M trimethylaluminum/hexane solution (34 μmol) was used instead of 31 μL of the 15 wt % triethylaluminum/toluene solution (34 μmol). At the bottom of the Schlenk flask, a whitish polymer was produced.

### Example 3

Polymerization was performed in the same procedure as in Example 1 except that 34 μl of a 1M triisobutylaluminum/hexane solution, (34 μmol) was used instead of 31 μL of the 15 wt % triethylaluminum/toluene solution (34 μmol). At the bottom of the Schlenk flask, a whitish polymer was produced.

### Example 4

Polymerization was performed in the same procedure as in Example 1 except that 34 μL of a 1M trinormaloctylaluminum/hexane solution (34 μmol) was used instead of 31 μL of the 15 wt % triethylaluminum/toluene solution (34 μmol). At the bottom of the Schlenk flask, a whitish polymer was produced.

### Example 5

Polymerization was performed in the same procedure as in Example 1 except that 34 μL of a 1M diethylaluminum chloride/hexane solution (34 μmol) was used instead of 31 μL of the 15 wt % triethylaluminum/toluene solution (34 μmol). At the bottom of the Schlenk flask, a whitish polymer was produced.

### Example 6

In a Schlenk flask, 10.0 g (69.4 mmol) of L-lactide, 7 mg (34 μmol) of aluminum triisopropoxide as a metal compound catalyst and a stirrer were placed. The mixture was vacuum-dried for 1 hour, and replacement by nitrogen gas was performed. In the nitrogen atmosphere, the mixture was heated to 140° C. After melting of the L-lactide was confirmed, 45 μL of a 15 wt % triethylaluminum/toluene solution (50 μmol) was added as an alkylaluminum compound catalyst, and polymerization was allowed to proceed for 10 minutes. At the bottom of the Schlenk flask, a whitish polymer was produced.

### Example 7

Polymerization was performed in the same procedure as in Example 6 except that 11 mg (34 μmol) of aluminum tris(acetylacetonate) was used instead of 7 mg (34 μmol) of aluminum triisopropoxide. At the bottom of the Schlenk flask, a whitish polymer was produced.

### Example 8

Polymerization was performed in the same procedure as in Example 6 except that 14 mg (34 μmol) of aluminum tris(ethylacetoacetate) was used instead of 7 mg (34 μmol) of aluminum triisopropoxide. At the bottom of the Schlenk flask, a whitish polymer was produced.

### Example 9

Polymerization was performed in the same procedure as in Example 6 except that 10 mg (34 μmol) of aluminum triL-lactate was used instead of 7 mg (34 μmol) of aluminum triisopropoxide. At the bottom of the Schlenk flask, a whitish polymer was produced.

### Example 10

Polymerization was performed in the same procedure as in Example 6 except that 9 mg (34 μmol) of zinc acetylacetonate(bis(2,4-pentadionato)zinc(II)) was used instead of 7 mg (34 μmol) of aluminum triisopropoxide. At the bottom of the Schlenk flask, a whitish polymer was produced.

### Example 11

Polymerization was performed in the same procedure as in Example 6 except that 10 mg (34 μmol) of tetraisopropoxytitanium(IV) was used instead of 7 mg (34 μmol) of aluminum triisopropoxide. At the bottom of the Schlenk flask, a whitish polymer was produced.

### Comparative Example 1

In a Schlenk flask, 10.0 g (69.4 mmol) of L-lactide, 7 mg (34 μmol) of aluminum triisopropoxide, and a stirrer were placed. The mixture was vacuum-dried for 1 hour, and replacement by nitrogen gas was performed. In the nitrogen atmosphere, the mixture was heated to 140° C. After melting of the L-lactide was confirmed, polymerization was allowed to proceed for 24 hours. At the bottom of the Schlenk flask, a white solid lactide was produced.

### Comparative Example 2

Polymerization was performed in the same procedure as in Comparative Example 1 except that 11 mg (34 μmol) of aluminum tris(acetylacetonate) was used instead of 7 mg (34 μmol) of aluminum triisopropoxide. At the bottom of the Schlenk flask, a polymer was produced.

### Comparative Example 3

Polymerization was performed in the same procedure as in Comparative Example 1 except that 14 mg (34 μmol) of aluminum tris(ethylacetoacetate) was used instead of 7 mg (34 μmol) of aluminum triisopropoxide. At the bottom of the Schlenk flask, a polymer was produced.

### Comparative Example 4

Polymerization was performed in the same procedure as in Comparative Example 1 except that 10 mg (34 μmol) of aluminum triL-lactate was used instead of 7 mg (34 μmol) of aluminum triisopropoxide. At the bottom of the Schlenk flask, a white solid lactide was produced.

### Comparative Example 5

Polymerization was performed in the same procedure as in Comparative Example 2 except that 9 mg (34 μmol) of zinc acetylacetonate(bis(2,4-pentadionato)zinc(II)) was used instead of 11 mg (34 μmol) of aluminum tris(acetylacetonate) and that the reaction time was 30 minutes. At the bottom of the Schlenk flask, a yellow polymer was produced.

### Comparative Example 6

Polymerization was performed in the same procedure as in Comparative Example 2 except that 10 mg (34 mol) of tetraisopropoxytitanium(IV) was used instead of 11 mg (34 μmol) of aluminum tris(acetylacetonate) and that the reaction time was 30 minutes. At the bottom of the Schlenk flask, a brown polymer was produced.

### Evaluation of Polymers

The polymer obtained in each Example was left to cool down and then dissolved in 100 mL of chloroform. The solution of the polymer in chloroform was added dropwise to 1 L of methanol. The polymer precipitate was collected, vacuum-dried at 60° C. for 3 hours, and measured for the weight for yield calculation. The obtained polymer was also dissolved in tetrahydrofuran and analyzed for the weight-average molecular weight in terms of standard polystyrene with the use of Shimadzu gel permeation chromatography system. Table 3 shows the evaluation results.

TABLE 3

| | | | Weight-average | |
|---|---|---|---|---|
| | Reaction | Polymer yield | molecular weight | |
| | time | (%) | (× 10⁻⁴) | M_{w}/Mₙ |
| Ex. 1 | 10 min | 86 | 13.5 | 1.40 |
| Ex. 2 | 10 min | 88 | 12.7 | 1.36 |
| Ex. 3 | 10 min | 82 | 14.3 | 1.41 |
| Ex. 4 | 10 min | 80 | 12.3 | 1.40 |
| Ex. 5 | 10 min | 83 | 12.8 | 1.45 |
| Ex. 6 | 10 min | 97 | 18.7 | 1.71 |
| Ex. 7 | 10 min | 99 | 23.8 | 2.25 |
| Ex. 8 | 10 min | 98 | 27.1 | 1.63 |
| Ex. 9 | 10 min | 95 | 17.4 | 1.70 |
| Ex. 10 | 10 min | 96 | 22.7 | 1.83 |
| Ex. 11 | 10 min | 94 | 25.8 | 2.39 |
| Comp. Ex. 1 | 24 h | 0 | — | — |
| Comp. Ex. 2 | 24 h | 63 | 9.0 | 1.53 |
| Comp. Ex. 3 | 24 h | 41 | 4.0 | 1.56 |
| Comp. Ex. 4 | 24 h | 0 | — | — |
| Comp. Ex. 5 | 30 min | 19 | 4.6 | 1.32 |
| Comp. Ex. 6 | 30 min | 38 | 6.8 | 1.43 |

As Table 3 clearly shows, Examples 1 to 11, where an alkylaluminum compound catalyst was used; gave a polylactic acid having a high molecular weight in good yield in a short reaction time of 10 minutes. Inter alia, Examples 6 to 11, where a metal compound catalyst was used in addition to an alkylaluminum compound catalyst, gave a polylactic acid having a higher molecular weight in better yield in the same reaction time as compared to Examples 1 to 5, where only an alkylaluminum compound catalyst was used.

In contrast, in Comparative Examples 1 to 6, where no alkylaluminum compound catalyst was used, the polymerization rate was extremely low. Even after 24 hours had passed, no polymer was obtained, or only a lower-molecular-weight polymer was obtained in poor yield. In addition, since the time to completion of the polymerization was long, discoloration of polylactic acid was a concern. Actually, the polylactic acid obtained in Comparative Example 6 was markedly turned brown and unpractical.

### INDUSTRIAL APPLICABILITY

According to the production method of the present invention, polylactic acid useful for, for example, clothing, daily commodities, drug materials, medical materials, and industrial materials for agriculture, fishery, civil engineering, construction, and the like can be efficiently produced in the presence of a green catalyst. Therefore, the present invention greatly contributes to industry, and resolution of environmental problems.

1. A method for producing polylactic acid comprising the step of ring-opening polymerization of lactide in the presence of an alkylaluminum compound represented by the following formula (1):
R¹ₙAlX₃₋ₙ (1)
(wherein n represents an integer of 1 to 3; R¹ may be the same or different and independently represents a linear or branched alkyl group having 1 to 10 carbon atoms; X may be the same or different and independently represents a halogen atom or a hydrogen atom; and Al represents an aluminum atom) as a ring-opening polymerization catalyst.

2. The method according to claim 1, wherein the alkylaluminum compound represented by the above formula (1) is at least one kind of compounds selected from the group consisting of trimethylaluminum, triethylaluminum, triisobutylaluminum, trinormalhexylaluminum, trinormalbutylaluminum, trinormaloctylaluminum, diethylaluminum chloride, ethylaluminumsesquichloride, ethylaluminum dichloride, and diisobutylaluminum hydride.

3. The method according to claim 1, further comprising the use of at least one kind of metal compounds selected from the group consisting of aluminum compounds (except the alkylaluminum compounds represented by the above formula (1)), zinc compounds, titanium compounds, zirconium compounds, magnesium compounds, and calcium compounds.

4. The method according to claim 3, wherein the metal compound is at least one kind selected from the group consisting of compounds represented by the formula (2) below, compounds represented by the formula (3) below, compounds represented by the formula (4) below, compounds represented by the formula (5) below, compounds represented by the formula (6) below, and compounds represented by the formula (7) below;
Al(OR²)₃ (2)
Zn(OR³)₂ (3)
Ti(OR⁴)₄ (4)
Zr(OR⁵)₄ (5)
Mg(OR⁶)₂ (6)
Ca(OR⁷)₂ (7)
(wherein R² to R⁷ may be the same or different and each represent a linear or branched alkyl group having 1 to 12 carbon atoms, an optionally substituted aryl group having 1 to 4 rings, or a linear or branched acyl group having 1 to 12 carbon atoms; Al represents an aluminum atom; Zn represents a zinc atom; Ti represents a titanium atom; Zr represents a zirconium atom; Mg represents a magnesium atom; and Ca represents a calcium atom).

5. The method according to claim 4, wherein the metal compound is at least one kind selected from the group consisting of aluminum triisopropoxide, aluminum trisecondarybutoxide, aluminum triethoxide, aluminum diisopropylate monosecondarybutyrate, aluminum ethylacetoacetate diisopropylate, aluminum tris(ethylacetoacetate), aluminum tris(acetylacetonate), aluminum bisethylacetoacetate monoacetylacetonate, (alkylacetoacetato)aluminum diisopropylate, aluminum trifluoroacetylacetonate, aluminum trilactate;
zinc acetylacetonate (bis(2,4-pentadionato)zinc(II)), zinc diacetate, zinc dimethacrylate, zinc dilactate; diisopropoxybis(ethylacetoacetate)titanium, tetraisopropoxytitanium(IV), tetranormalbutoxytitanium, tetrakis(2-ethylhexyloxy)titanium, tetrastearyloxytitanium, tetramethoxytitanium, diisopropoxybis(acetylacetonato)titanium, diisopropoxybis(2-ethyl-1,3-hexanediolato)titanium, diisopropoxybis(triethanolaminato)titanium, di(2-ethylhexoxy)bis(2-ethyl-1,3-hexanediolato)titanium, di-normalbutoxy bis(triethanolaminato)titanium, and tetraacetylacetonatetitanium.

6. The method according to claim 5, wherein the metal compound is at least one kind selected from the group consisting of aluminum triisopropoxide, aluminum tris(ethylacetoacetate), aluminum tris(acetylacetonate), aluminum trilactate, zinc acetylacetonate(bis(2,4-pentadionato)zinc(II)), tetraisopropoxytitanium(IV), tetranormalbutoxytitanium, and tetrakis(2-ethylhexyloxy)titanium.

7. The method according to claim 1, wherein the usage of the alkylaluminum compound represented by the formula (1) is 0.00001 to 1 mol % relative to 100 parts by weight of lactide.

8. The method according to claim 3, wherein the usage of the metal compound is 0.00001 to 1 mol % relative to 100 parts by weight of lactide.

9. The method according to claim 3, wherein the molar ratio of the usage of the alkylaluminum compound represented by the formula (1) relative to the usage of the metal compound is 0.1 to 10 equivalents.

10. The method according to claim 1, wherein the lactide to be subjected to the polymerization is in a molten state.

11. The method according to claim 10, wherein the reaction temperature is 100 to 200° C.
